(19) United States
(12) Patent Application Publication
(10) Pub. No.: US 2022/0067502 A1
(43) Pub. Date: Mar. 3, 2022

(54) CREATING DEEP LEARNING MODELS FROM KUBERNETES API OBJECTS

(71) Applicant: Tomer MENACHEM SAGI, Portland, OR (US)

(72) Inventor: Tomer MENACHEM SAGI, Portland, OR (US)

(21) Appl. No.: 17/002,585

(22) Filed: Aug. 25, 2020

(51) Int. Cl. G06N 3/08; G06F 9/455; H04L 29/08

(52) U.S. Cl. CPC G06N 3/08; G06F 9/45558; G06F 2009/45587; G06F 2009/45595; G06F 2009/45562; H04L 67/10

(57) ABSTRACT

A method and a system for creating and training deep learning models by extending the Kubernetes api with new deep learning model object, receiving a model object from the Kubernetes API server, converting a declarative high level specification of such object, into low level executable program and executing the low level program to train and test the deep learning model.

### FIELD

The present disclosure relates to systems and techniques for data analysis and statistical machine learning.

### BACKGROUND

A machine learning model is a software program that can make predictions based on historical data.

A deep learning model is a machine learning based on artificial neural network. A deep learning model is composed of layers of neurons. Currently Deep learning models achieved state of the art results in many machine learning tasks like computer vision and speech recognition.

To train a deep learning model, a data scientist creates a computer program using a computer language. First, the data scientist chooses the deep learning framework to use (TensorFlow or pytorch). Next, the data scientist specifies the said model architecture (for example, the number of layers, what optimizer to use, the loss function, etc) and the data sources for the training and testing data. Next the data scientist specifies the computing devices (which include both a CPU, memory, and storage), on which the actual training will occur. Next, the data scientist preforms the actual training by running the said program on the computing device. At the end of the training, the program generates the deep learning model

A container is an application packaging and runtime technology which support running computer programs in isolation from other programs. A container image has all the needed program and configuration files for the execution of the program. A container engine is a system that understand how to create containers (a running program) from a container image, and how to run the program within the container.

A container orchestrator is a program that manages one or more container engines running within a group of computer hardware. The container orchestrator decides where to run a given container, how to create more containers based on application demand, and what to do in case of a failure.

Kubernetes is a container orchestrator comprised of number of compute nodes (real machine or virtual machines), each running a container engine. Kubernetes manages the execution of containers across those nodes.

A computation request in Kubernetes, is represented a Kubernetes API object. To start an execution of a program in Kubernetes, the user creates a new API object and send the request to the Kubernetes API server. The computations request describes what is the desired state of the Kubernetes API object. The processing of the object's desired state is done by the controller-manager module. When the computations request is sent to Kubernetes, the controller manager is notified, and creates the actual containers to run the application.

Kubernetes pre-defined a set of core objects (Pod, Deployment, etc). In addition, Kubernetes offer a way to extends the set of API objects. To create a new API object type, the Kubernetes administrator creates a new custom resource definition objects, which define the attribute of the new API object and add it to the cluster. In addition, the user adds new controller module, which knows how to process the new API object.

### SUMMARY

The present invention is directed to apparatus and a method for creating deep learning models by extending the Kubernetes API with a new deep learning model API object. The new deep learning model API object describes the deep learning model architecture and training requirement.

The model creation and training method is implemented by a deep learning controller module and a trainer module. The deep learning controller module listens to new deep learning API objects creation events. Upon receiving the model creation event, the said controller creates the deep learning model trainer and send the object to the trainer module.

The said trainer module converts the deep learning API object into a training instruction expressed in common deep learning framework (TensorFlow or pytorch), perform the actual training and store the trained deep learning network model in a storage device.

These and other features, aspects and advantages of the present invention will become better understood with reference to the following drawings, description, and claims.

### BRIEF DESCRIPTION OF THE DRAWING

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments. The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a simplified block diagram of a computer system according to some embodiments.

FIG. 2 is simplified block diagram of a Kubernetes cluster environment together with the deep training controller and the training manager according to some embodiments.

FIG. 3 is a simplified flow diagram of a deep learning controller method.

FIG. 4 is a simplified flow diagram of a trainer method.

FIG. 5 is a simplified view of a deep learning model object description in yaml file in accordance with some embodiments.

FIG. 6 is a simplified block diagram of a single machine and its components, in accordance with various embodiments.

### DETAILED DESCRIPTION

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing embodiments only and is not intended to be limiting of the technology. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

information technology (IT) organizations face a demand to gain value from the organization data assets. Machine learning is a technology that can increase the value of data assets, by generating predictions about events or entities inside or outside the organization.

The core artifact of the machine learning is the machine learning model. A machine learning model is a computer program that is learn from historical data and can make prediction on unseen data.

Recent advances of machine learning are in a subfield of deep neural networks. A deep neural network is a machine learning model which is composed of layers of artificial neurons. To train deep neural network model, the data scientist uses a low-level programming language (for example, python), which is used to describe the layers of the network, the optimizer, and one or more hyper parameters. The data scientist starts the training process by allocating one or more computer nodes. The resulting trained model is than used to make prediction.

Describing the structure of the deep neural network as well as the training process is a difficult challenge. Some IT data science departments have a large staff dedicated to creating the training programs and carry the training itself. Some embodiments of the present technology provide a way for a declarative description of the deep neural network, at a high level of abstraction. Abstraction is a technique for managing complexity by establishing a level of complexity which suppresses the more complex details below the current level. The high-level declarative description may be compiled to produce the low-level training program and carry on the training automatically.

Kubernetes is a software system which provide a declarative approach for describing computation. Each object in Kubernetes contains a specification part and a status part. The specification part describes the desired state of the object, and the status part describe its actual state. Objects are created by sending requests to the Kubernetes API server, which store them in an object store. Once new objects is created, a special module in Kubernetes try to reconcile the desired state (as defined in the object specification part) with the actual status.

Some embodiments of the present technology provide a way to represent a deep neural network structure and its training process as a Kubernetes API object. Some other embodiments provide a method to compile the declarative representation into low-level program. Some other embodiments provide a method to execute the low-level program in order to create a trained model

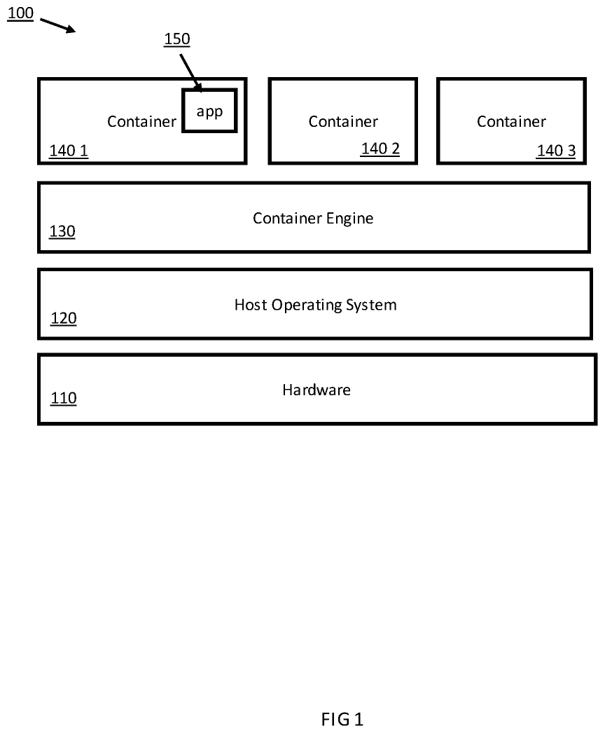

FIG. 1 depicts environment 100 according to various embodiments.

Environment 100 includes hardware 110, host operating system 120, container engine 130, and containers 140 1-140 z. In some embodiments, hardware 110 is described in environment 600. Host operating system 120 runs on hardware 110 and can also be referred to as the host kernel. By way of non-limiting example, host operating system 120 can be at least one of: Linux, Red Hat Atomic Host, CoreOS, Ubuntu Snappy, and the like. Host operating system 120 allows for multiple (instead of just one) isolated user-space instances (e.g., containers 140 1-140 z) to run in host operating system 120 (e.g., a single operating system instance).

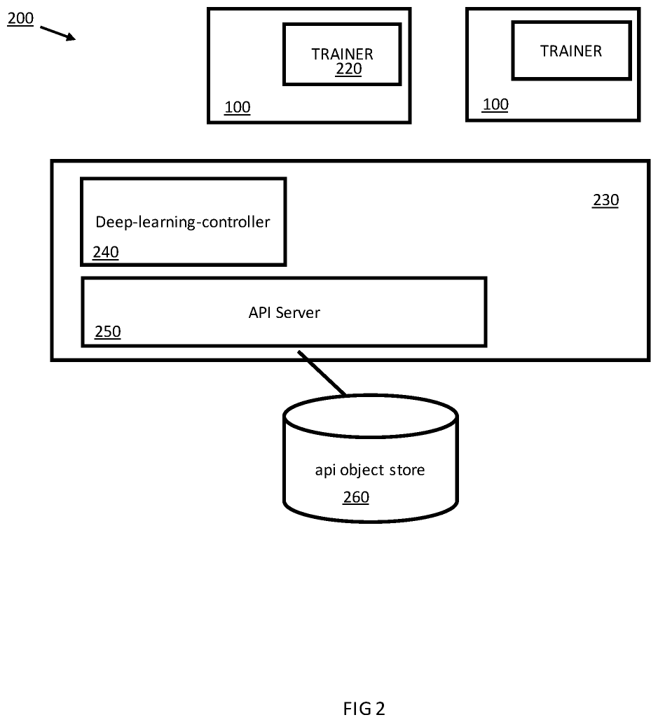

Host operating system 120 can include a container engine 130. Container engine 130 can create and manage containers 140 1-140 z, for example, using an (high-level) application programming interface (API). By way of non-limiting example, container engine 130 is at least one of Docker, Rocket (rkt), and the like. For example, container engine 130 may create a container (e.g., one of containers 140 1-140 z) using an image. An image can be a (read-only) template comprising multiple layers and can be built from a base image (e.g., for host operating system 120) using instructions (e.g., run a command, add a file or directory, create an environment variable, indicate what process (e.g., application or service) to run, etc.). Each image may be identified or referred to by an image type. In some embodiments, images (e.g., different image types) are stored and delivered by a system (e.g., server side application) referred to as a registry or hub (not shown in FIG. 2).

Container engine 130 can allocate a filesystem of host operating system 120 to the container and add a read-write layer to the image. Container engine 130 can create a network interface that allows the container to communicate with hardware 110 (e.g., talk to a local host). Container engine 130 can set up an Internet Protocol (IP) address for the container (e.g., find and attach an available IP address from a pool). Container engine 130 can launch a process (e.g., application or service) specified by the image (e.g., run an application, such as one of APP 150 1-250 z, described further below). Container engine 130 can capture and provide application output for the container (e.g., connect and log standard input, outputs and errors). The above examples are only for illustrative purposes and are not intended to be limiting.

Containers 140 1-140 3 can be created by container engine 130. In some embodiments, containers 140 1-140 3, are each an environment as close as possible to an installation of host operating system 120, but without the need for a separate kernel. For example, containers 140 1-140 3 share the same operating system kernel with each other and with host operating system 120. Each container of containers 140 1-140 3 can run as an isolated process in user space on host operating system 120. Shared parts of host operating system 120 can be read only, while each container of containers 140 1-140 3 can have its own mount for writing.

Containers 140 1-140 z can include one or more applications (APP) 150 (and all of their respective dependencies). For our propose APP 150 can be either a deep learning controller or a trainer.

FIG. 2 illustrates environment 200, according to some embodiments.

Environment 200 shows the deployment in a Kubernetes cluster. Environment 200 includes the Orchestration layer 230, which include the Kubernetes API server 250, and the deep learning controller module 240. Environment 200 also shows the storage for the Kubernetes objects 260. By way of non-limiting example, the Kubernetes object store 260 can be etcd. Environment 200 also include one or more environments 100 1-100 3, which are used to run the trainer module. in a respective environment of environments 100 1-100 3) can be a container as described in relation to containers 140 1-140 3 (FIG. 1).

In some embodiments, to manage and deploy containers, the master node 230 and the worker node 100, receives one or more image types (e.g., named images) from a data storage and content delivery system referred to as a registry (not shown in FIG. 2). By way of non-limiting example, the registry can be the Google Container Registry or Docker Hub container registry.

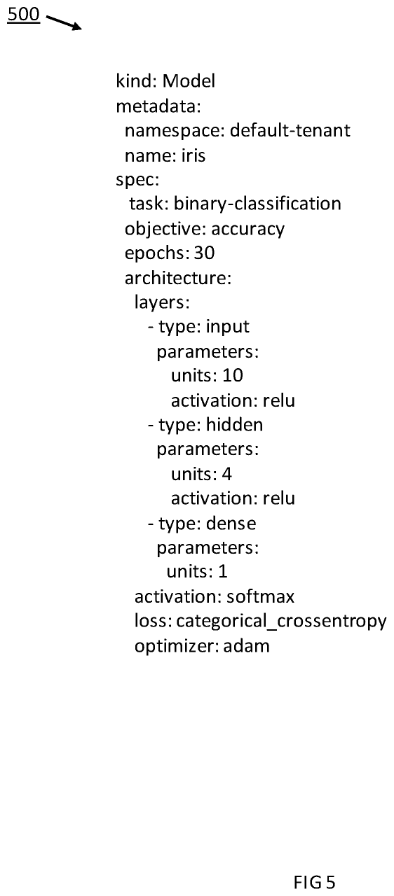

Orchestration layer 230 can maintain (e.g., create and update) the database about Kubernetes object 260. The Kubernetes objects database 260 can include reliable and authoritative description concerning deep learning model objects. FIG. 5 illustrates metadata example 500, a non-limiting example of deep learning object. By way of illustration, the deep learning model example 500 indicates for a model at least one of: the model layers, the optimizer and the number of epochs needed to train the model.

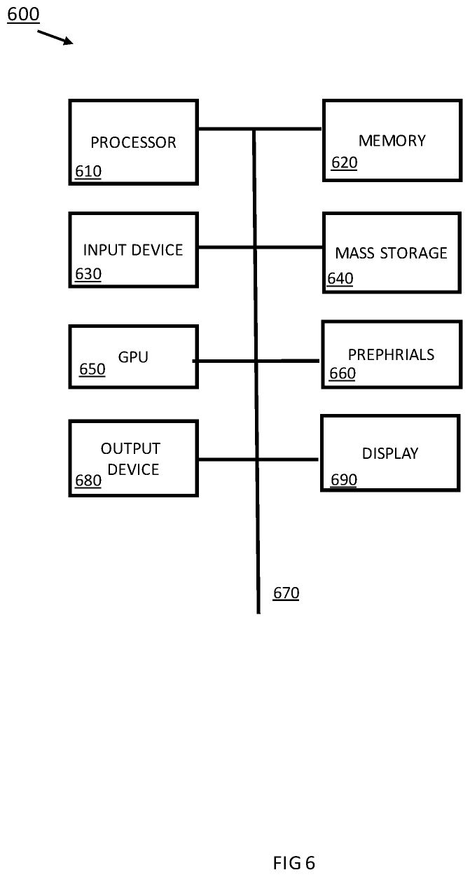

Referring back to FIG. 2, the deep learning model controller 240 can receive deep learning model data from the Kubernetes object store 260. for example, through application programming interface (API) 250. Other interfaces can be used to receive data from the object store 260. In some embodiments, once the said controller 240, receive a new deep learning model api object, it would find or create a new trainer module 220, and send it the said object. The trainer module 220, will convert the deep learning API object into low level python code in deep learning framework, and will run and train the model. While training, the trainer module 220, uses the hardware, storage and memory as described in FIG. 6.

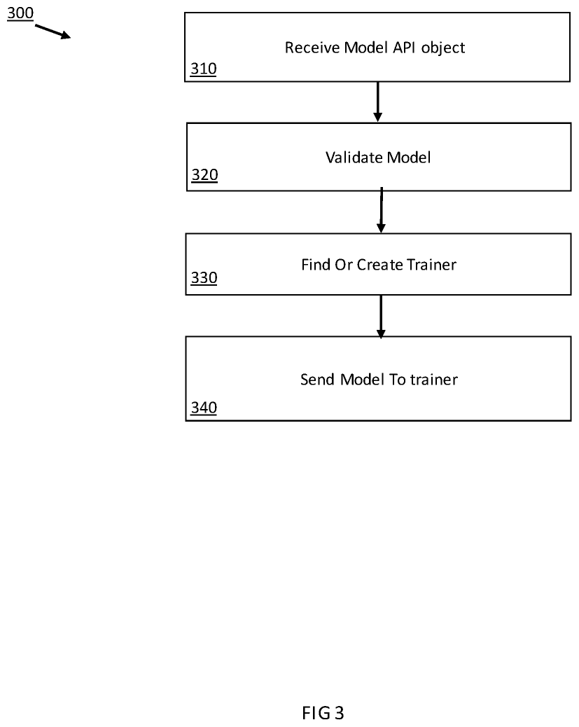

FIG. 3 illustrates a method 300 which is executed by performed by the deep-learning controller module 240, according to some embodiments. The method is performed autonomically without intervention by an operator. At step 310, the deep learning model object 500 (FIG. 5) can be received. For example, when the Kubernetes user sent a request to the API server. At step 320, the new deep learning api object is validated. At step 330, the trainer is selected or created. At step 340 the controller module send the training request to the trainer module.

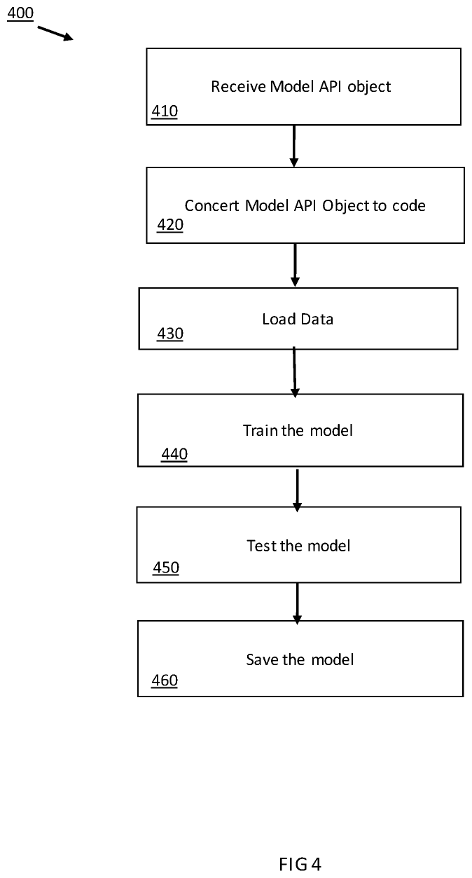

FIG. 4 illustrates a method 400 which is executed by the deep-learning trainer module 220. At step 410 the trainer receives the request to train from the deep learning controller module. At step 420 the trainer compiles the deep learning API object representation, into a low-level programming instruction (For example, python pythorch). At step 430, the training of the model start by loading the training data into the node memory. In step 440 the trainer module performs the training. In step 450, the trainer tests the created deep learning model against test data and calculate training results. In step 460, the trainer saves the trained model into persistent storage.

FIG. 5 illustrates a Kubernetes deep learning api object 500. By way of illustration, example 500 indicates for a model at least one of: the modelling task (e.g. binary classification) indicating the machine learning task type. The objective metric (e.g. accuracy) indicating the metric that the trainer will use to calculate the model performance. The number of epochs, indicating the number of iterations done during the model optimization process. The model optimizer (e.g. adam) which is used to update the model parameters during training. The model architecture which is comprised of one or more different model layers and their parameters. The loss function indicating how to adjust the model weights during training.

FIG. 6 illustrates an exemplary computer system 600 that may be used to implement some embodiments of the present invention. The computer system 600 in FIG. 6 may be implemented in the contexts of the likes of computing systems, networks, servers, or combinations thereof. The computer system 600 in FIG. 6 includes one or more processor unit(s) 610 and main memory 620. Main memory 620 stores, in part, instructions and data for execution by processor unit(s) 610. Main memory 620 stores the executable code when in operation, in this example. The computer system 600 in FIG. 6 further includes a mass data storage 640, output devices 680, user input devices 630, a graphics display system 690, a graphical processing unit 650, and peripheral device(s) 660.

The components shown in FIG. 6 are depicted as being connected via a single bus 690. The components may be connected through one or more data transport means. Processor unit(s) 610 and main memory 620 are connected via a local microprocessor bus, and the mass data storage 640, peripheral device(s) 660, graphical processing unit 650, and graphics display system 690 are connected via one or more input/output (I/O) buses.

Computer program code for carrying out operations for aspects of the present technology may be written in any combination of one or more programming languages, including an object oriented programming language such as JAVA, Python or Go or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present technology are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The description of the present technology has been presented for purposes of illustration and description but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

1. A method for specifying and training deep learning neural networks in a Kubernetes environment comprising:
Extending the Kubernetes API with new deep learning model object. The new API object comprised of specification of the model architecture, the optimizer type and other training parameters.
Creating a new Kubernetes deep learning API object and submitting it to the Kubernetes API server.
Receiving said deep learning model object request about a new deep learning model object from a container orchestration layer.
Generating a low-level program associated with the deep learning model object.
Loading the training dataset
Performing the actual training by running the generated program
Storing the trained model and the training results.

2. The method of claim 1, in which the deep learning api object is received from the container orchestration layer using at least an application programming interface (API).

3. The method of claim 1, in which the deep learning model api object definition might include at least one of an deep learning task text classification, text translation, image recognition, object detection, Language understanding, reinforcement learning or other as well as the training parameters which might include: the number of training gpu, the loss function, the number of epochs, the general architecture type CNN, RNN, LSTM.

4. The method of claim 1, in which the generation of the low level program and the training is done by a training controller module, running inside a container and listening to Kubernetes API objects events.

5. The method of claim 1, in which the data is loaded and saved to/from a local file system or from an API offered by a cloud provider.

6. A system for creating and training deep learning models in a container-based virtualization environment comprising:
a hardware processor; and
a memory coupled to the hardware processor, the memory storing instructions which are executable by the hardware processor to perform a method comprising: Extending the Kubernetes API with new deep learning model object. The new API object comprised of specification of the model architecture, the optimizer type and other training parameters.
Creating a new Kubernetes deep learning API object and submitting it to the Kubernetes API server.
Receiving said deep learning model object request about a new deep learning model object from a container orchestration layer.
Generating a low-level program associated with the deep learning model object.
Loading the training dataset
Performing the actual training by running the generated program
Storing the trained model and the training results.

7. The method of claim 6, in which the deep learning api object is received from the container orchestration layer using at least an application programming interface (API).

8. The method of claim 6, in which the deep learning model api object definition might include at least one of an deep learning task text classification, text translation, image recognition, object detection, Language understanding, reinforcement learning or other as well as the training parameters which might include: the number of training gpu, the loss function, the number of epochs, the general architecture type CNN, RNN, LSTM.

9. The method of claim 6, in which the generation of the low level program and the training is done by a training controller module, running inside a container and listening to Kubernetes API objects events.

10. The method of claim 6, in which the data is loaded and saved to/from a local file system or from an API offered by a cloud provider.

15. A system for creating and training deep learning models in a container-based virtualization environment comprising:
A non-transitory computer-readable storage medium having embodied thereon a program, the program being executable by a processor to perform a method for security in a container-based virtualization environment, the method comprising:
Creating a new Kubernetes deep learning API object and submitting it to the Kubernetes API server.
Receiving said deep learning model object request about a new deep learning model object from a container orchestration layer.
Generating a low-level program associated with the deep learning model object.
Loading the training dataset
Performing the actual training by running the generated program
Storing the trained model and the training results.

16. The method of claim 15, in which the deep learning api object is received from the container orchestration layer using at least an application programming interface (API).

17. The method of claim 15, in which the deep learning model api object definition might include at least one of an deep learning task text classification, text translation, image recognition, object detection, Language understanding, reinforcement learning or other as well as the training parameters which might include: the number of training gpu, the loss function, the number of epochs, the general architecture type CNN, RNN, LSTM.

18. The method of claim 15, in which the generation of the low level program and the training is done by a training controller module, running inside a container and listening to Kubernetes API objects events.

19. The method of claim 15, in which the data is loaded and saved to/from a local file system or from an API offered by a cloud provider.
